(19) United States
(12) Patent Application Publication
(10) Pub. No.: US 2012/0006877 A1
(43) Pub. Date: Jan. 12, 2012

(54) SAFETY SYSTEM, METHOD, AND NAIL GUN WITH THE SAFETY SYSTEM

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/872,611

(22) Filed: Aug. 31, 2010

(30) Foreign Application Priority Data
Jul. 9, 2010 (TW) 99122781

(51) Int. Cl. B25C 1/00

(52) U.S. Cl. 227/2

(57) ABSTRACT

A safety method for a nail gun includes a time-of-flight (TOF) camera capturing an image in front of the nail gun and obtaining data about distances between a number of points in the scene and the TOF camera; building a three dimension (3D) model of the scene according to the image and the data about distances between the plurality of points in the scene and the TOF camera; checking the 3D model to determine whether there is a person in front of the nail gun; and controlling a switch to cut off a power supply from the nail gun upon the condition that there is a person in front of the nail gun.

### CROSS-REFERENCE TO RELATED APPLICATIONS

Relevant subject matter is disclosed in the co-pending U.S. patent applications (Attorney Docket No. US33292) which are assigned to the same assignee as named herein.

### BACKGROUND

1. Technical Field

The present disclosure relates to a safety system and a safety method for a nail gun, and a nail gun including the safety system and method.

2. Description of Related Art

A nail gun is a tool used to drive nails into wood or some other kind of material. Every year many people go to emergency rooms with injuries from nail guns. As a result, a safe nail gun is needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a safety system including a storage unit.

FIG. 2 is a schematic view of a nail gun using the safety system of FIG. 1.

FIG. 3 is a block diagram of the storage unit of FIG. 1.

FIG. 4 is a flowchart of an exemplary embodiment of a safety method for a nail gun.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

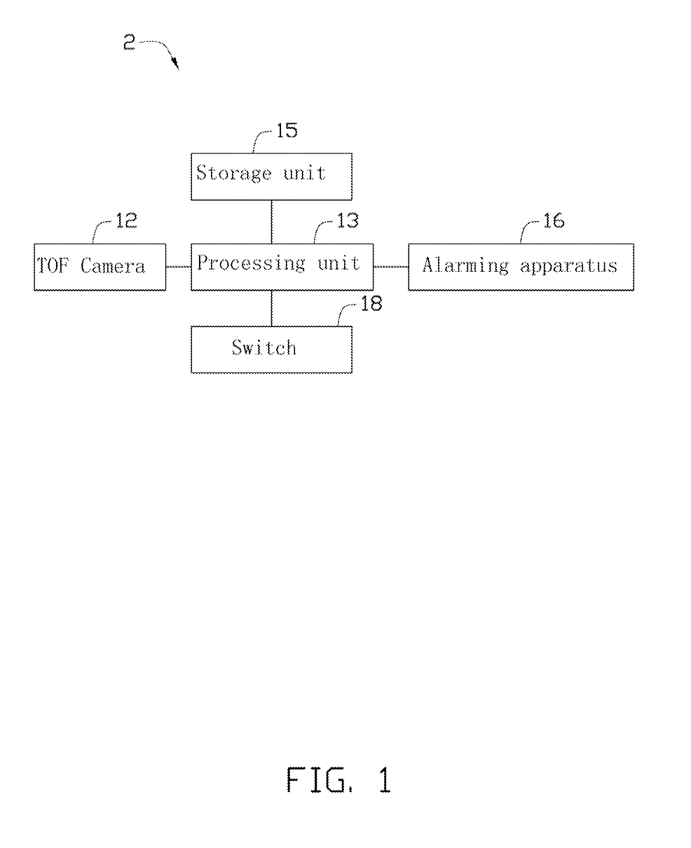

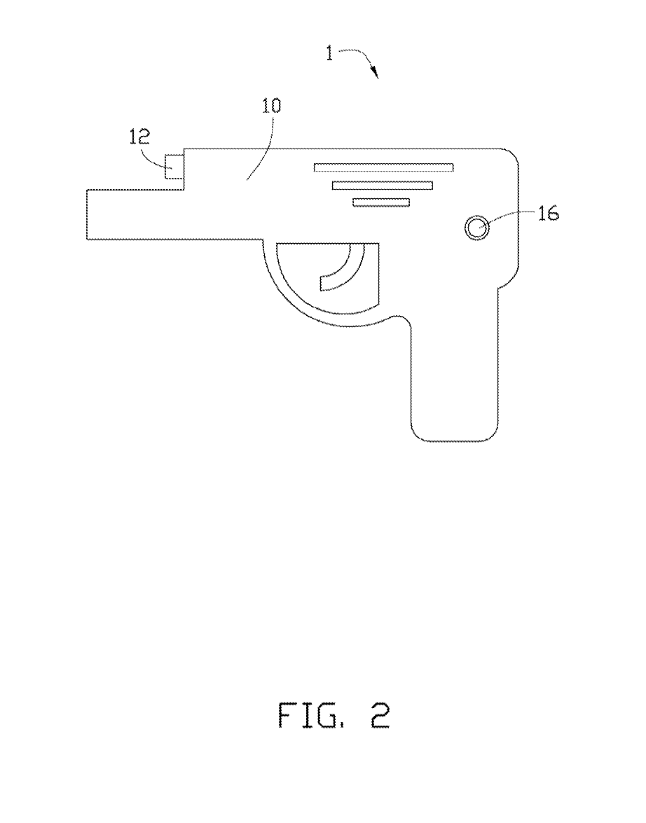

Referring to FIGS. 1 and 2, an exemplary embodiment of a nail gun 1 includes a body 10, a time-of-flight (TOF) camera 12, a processing unit 13, a storage unit 15, an alarm apparatus 16, and a switch 18. The TOF camera 12, the processing unit 13, the storage unit 15, the alarm apparatus 16, and the switch 18 compose a safety system 2. The safety system 2 can prevent dangerous operation mistakes with the nail gun 1.

The TOF camera 12 is mounted on a front side of the body 10, to capture an image. The alarm apparatus 16 is mounted on a surface of the body 10. The switch 18 is located inside of the body 10, to cut off or connect the body 10 to a power supply.

The TOF camera 12 is a camera system that creates distance data between a plurality of points in front of the body 10 and the TOF camera 12. When the TOF camera 12 shoots a scene in front of the body 10, the TOF camera 12 sends radio frequency (RF) signals. The RF signals would return to the TOF camera 12 when the RF signals meet an object, such as a desk in the scene. As a result, the distance data can be obtained according to time differences between sending and receiving the RF signals of the TOF camera 12.

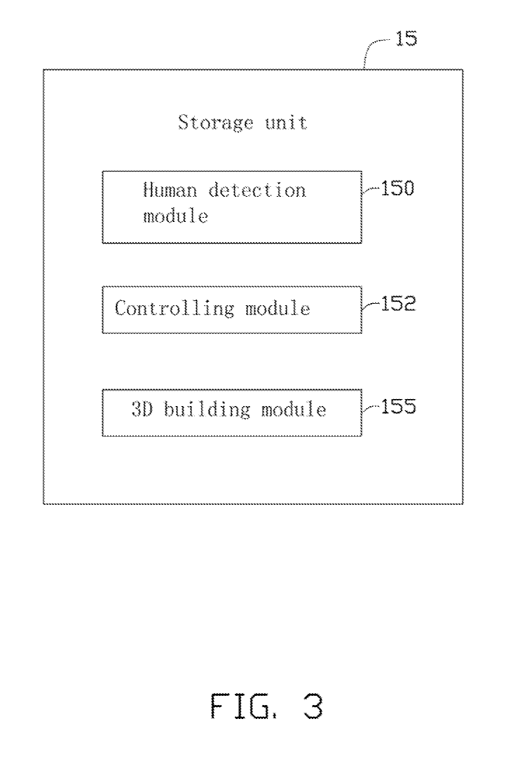

Referring to FIG. 3, the storage unit 15 includes a three dimension (3D) building module 155, a human detection module 150 and a controlling module 152 which may include one or more computerized instructions executed by the processing unit 13.

The 3D model building module 155 builds a 3D model of the scene in front of the body 10 according to the image captured by the TOF camera 12 and the data about distances between a plurality of points in the scene and the TOF camera 12. In the embodiment, according to the data about distances between a plurality of points in the scene in front of the body 10 and the TOF camera 12, the plurality of points in the scene has coordinates relative to the TOF camera 12. The 3D model building module 155 can obtain a 3D mathematical model according to the coordinates of the plurality of points and the image. The 3D mathematical model can be regarded as the 3D model of the scene in front of the body 10.

The human detection module 150 checks the 3D model obtained by the 3D model building module 155 to determine whether there is a person in front of the body 10. It is noteworthy that the human detection module 150 uses well known human recognition technology when analyzing the 3D model.

When the human detection module 150 determines that there is a person 3D model obtained by the 3D model building module 155, the controlling module 152 activates the alarm apparatus 16, such as a blinking LED to light, and controls the switch 18 to cut off power to the body 10. After the switch 18 cuts off the power and a preset interval of time, such as 5-10 seconds, elapses, the controlling module 152 then controls the switch 18 to reconnect the power supply to the body 10, and deactivates the alarm apparatus 16.

As a result, when there is a person in front of the nail gun 1, the controlling module 152 cuts off power to the body 10 to stop the nail gun 1 from working, thus to ensure the safety of the person.

The alarm apparatus 16 acts as an indicator to operators that the safety system 2 has been activated and is the cause of loss of power to the nail gun 1. When the alarm apparatus 16 is activated, it indicates that the safety system 2 is activated, and the nail gun 1 will be powered on after 5-10 seconds, but will be immediately powered down again if a person is again detected to be in front of the body 10. If the nail gun 1 is unexpectedly powered down, an operator will know right away it is not because of the safety system 2 if the alarm apparatus 16 is not activated, and some other problem exists

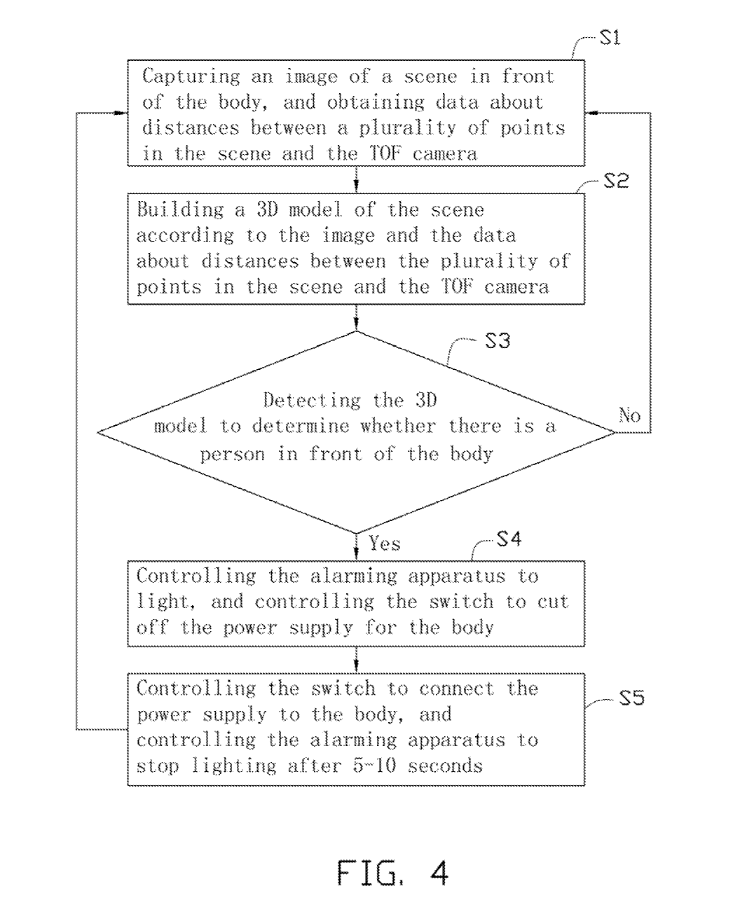

FIG. 4 shows a safety method for the nail gun 1, which includes the following:

In step S1, the TOF camera 12 captures an image of the scene in front of the body 10. The TOF camera 12 further gathers data about distances between a plurality of points in the scene and the TOF camera 12. The TOF camera 12 is a camera system that gathers data about distances between the plurality of points in the scene and the TOF camera 12. When the TOF camera 12 is recording the scene, the TOF camera 12 emits signals. The signals are reflected back to the TOF camera 12 when the signals meet a feature in the scene, such as a desk. As a result, the data about distances can be obtained according to time differences between sending and receiving the signals of the TOF camera 12.

In step S2, the 3D model building module 155 builds a 3D model of the scene in front of the body 10 according to the image captured by the TOF camera 12 and the data about distances between the plurality of points in the scene and the TOF camera 12. In the embodiment, according to the data about distances between a plurality of points in the scene in front of the body 10 and the TOF camera 12, the plurality of points in the scene has coordinates relative to the TOF camera 12. The 3D model building module 155 can obtain a 3D mathematical model according to the coordinates of the plurality of points and the image. The 3D mathematical model can be regarded as the 3D model of the scene in front of the body 10.

In step S3, the human detection module 150 checks the 3D model obtained by the 3D model building module 155 to determine whether there is a person in front of the body 10. If it is determined that there is a person in front of the body 10, the process flows to step S3. If it is determined that there is no person in front of the body 10, the nail gun 1 continues to operate, and flow returns to step S1.

In step S4, the controlling module 152 activates the alarm apparatus 16, and controls the switch 18 to cut off the power to the body 10.

In step S5, after the switch 18 cuts off the power to the body 10 for a preset interval of time, such as 5-10 seconds, the controlling module 152 then controls the switch 18 to reconnect the power supply to the body 10, and deactivates the alarm apparatus 16. Then the process flows to step S1.

It can be understood that the safety system can be used on other tools, such as an anesthesia gun.

The foregoing description of the embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A safety system for a nail gun, the system comprising:
a time-of-flight (TOF) camera to capture an image of a scene and obtain data about distances between a plurality of points in the scene and the TOF camera;
a switch to cut off or connect a power supply from or to the nail gun;
a processing unit; and
a storage unit connected to the processing unit, the camera, and the switch, and storing a plurality of programs to be executed by the processing unit, wherein the storage unit comprises:
a three dimension (3D) building module to build a 3D model of the scene according to the image of the scene and the data about distances between the plurality of points in the scene and the TOF camera;
a human detecting module to check the 3D model obtained by the 3D building module to determine whether there is a person in front of the nail gun; and
a controlling module to control the switch to cut off the power supply from the nail gun upon the condition that there is a person in front of the nail gun.

2. The safety system of claim 1, further comprising an alarm apparatus, wherein the controlling module activates the alarm apparatus upon the condition that there is a person in front of the nail gun.

3. The safety system of claim 1, wherein after the switch cuts off the power supply from the nail gun for a preset interval of time, the controlling module then controls the switch to reconnect the power supply to the nail gun.

4. The safety system of claim 2, wherein after the switch cuts off the power supply from the nail gun for a preset interval of time, the controlling module then deactivates the alarm apparatus.

5. A safety method for a nail gun, the method comprising:
capturing an image of a scene, and obtaining data about distances between a plurality of points in the scene and a time-of-flight (TOF) camera by the TOF camera;
building a three dimension (3D) model of the scene according to the image and the data about distances between the plurality of points in the scene and the TOF camera;
checking the 3D model to determine whether there is a person in front of the nail gun; and
controlling a switch to cut off a power supply from the nail gun upon the condition that there is a person in front of the nail gun.

6. The safety method of claim 5, further comprising:
activating an alarm apparatus upon the condition that there is a person in front of the nail gun.

7. The safety method of claim 5, further comprising:
controlling the switch to reconnect the power supply to the nail gun after the switch cuts off the power supply from the nail gun for a preset interval of time.

8. The safety method of claim 5, further comprising:
deactivating the alarm apparatus after the switch cuts off the power supply from the nail gun for a preset interval of time.

9. A nail gun comprising:
a body;
a time-of-flight (TOF) camera mounted in front of the body to capture an image of a scene in front of the body and obtain data about distances between a plurality of points in the scene and the TOF camera;
a switch; and
a safety system to build a 3D model of the scene according to the image of the scene and the data about distances between the plurality of points in the scene and the TOF camera, and to check the 3D model to determine whether there is a person in front of the body, and control the switch to cut off a power supply from the body according to the determination result.

10. The nail gun of claim 9, wherein the safety system comprises:
a three dimension (3D) building module to build the 3D model of the scene according to the image of the scene and the data about distances between the plurality of points in the scene and the TOF camera;
a human detecting module to check the 3D model obtained by the 3D building module to determine whether there is a person in front of the body; and
a controlling module to control the switch to cut off the power supply from the nail gun upon the condition that there is a person in front of the body.

11. The nail gun of claim 9, further comprising an alarm apparatus, wherein the controlling module activates the alarm apparatus upon the condition that there is a person in front of the body.

12. The nail gun of claim 9, wherein after the switch cuts off the power supply from the nail gun for a preset interval of time, the controlling module then controls the switch to reconnect the power supply to the nail gun.

13. The nail gun of claim 11, wherein after the switch cuts off the power supply from the nail gun for a preset interval of time, the controlling module then deactivates the alarm apparatus.
